(19) United States
(12) Patent Application Publication
(10) Pub. No.: US 2001/0042038 A1
(43) Pub. Date: Nov. 15, 2001

(54) Method and system for conducting an auction for resources

(76) Inventor: Anirudha Phatak, Rochester Hills, MI (US)

Correspondence Address: PERKINS COIE LLP, PATENT-SEA, P.O. BOX 1247, SEATTLE, WA, 98111-1247, US

(21) Appl. No.: 09/738,169

(22) Filed: Dec. 14, 2000

Related U.S. Application Data
(60) Provisional application No. 60/170,836, filed on Dec. 14, 1999.

(51) Int. Cl. G06F 17/60

(52) U.S. Cl. 705/37

(57) ABSTRACT

A method and system for selecting a resource. The resource system receives resource requirements that indicate target attributes of a target resource that is desired. The resource system receives offers to provide candidate resources to fill the resource requirements in an auction environment. Each candidate resource has candidate attributes that specify the characteristics of the candidate resource. The resource system generates a match rating for each candidate resource that indicates how closely the candidate attributes match the target attributes. The resource system then uses the match ratings to select a candidate resource whose candidate attributes best match the target attributes.

### TECHNICAL FIELD

Method and system for conducting an auction and, more particularly, to method and system for conducting an auction for resources over the Internet.

### BACKGROUND OF THE INVENTION

Because it facilitates electronic communications between vendors and purchasers, the Internet is increasingly being used to “electronic commerce.”The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. Although many of the commercial transactions that are performed today could be performed via electronic commerce, the acceptance and wide-spread use of electronic commerce depends, in large part, upon the ease-of-use of conducting such electronic commerce. If electronic commerce can be easily conducted, then even the novice computer user will choose to engage in electronic commerce. Therefore, it is important that techniques be developed to facilitate conducting electronic commerce.

The World Wide Web portion of the Internet is especially conducive to conducting electronic commerce. Many web servers have been developed through which vendors can advertise and sell product. The products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. The server computer system then typically confirms the order by sending a confirming web page to the client computer system and schedules shipment of the items.

The temporary employment industry has thrived based on the needs of employers for temporary employees and the desire of employees to work on a temporary basis. It is, however, difficult for an employer to find temporary employees with both the needed skills and the needed availability at a reasonable price. To assist in finding such temporary employees, an employer may register their needs with various temporary employment agencies. These agencies select their own candidates who best match the employer's needs and present those candidates to the employer. The employer can then review the presented candidates to identify which candidates best meets their needs. The employers may then interview the identified candidates and hire one of those candidates based on then interview.

Although the temporary employment industry has thrived, it has encountered many problems. For example, it is very difficult for a temporary employment agency to assess of the needs of employer. In particular, there is no standard technique for specifying the required or desired skills of a temporary employee. As a result, the agencies may waste time presenting candidates who have no chance of being hired by the employer. As another example, it is very difficult for an employer to evaluate the degree to which candidates meet the employer's needs. As a result, the employer may hire a candidate who is not the most qualified candidate. As another example, employers often limit their search for temporary employees to a small geographic area. As a result of this limited search, an employer may be forced to hire a candidate at a high price or with less than optimal skills.

### BRIEF DESCRIPTION OF THE DRAWINGS

FIG. 1 illustrates a sample web page for entry of “standard” job requirements.

FIG. 2 illustrates a sample web page for entry of advance options.

FIG. 3 illustrates a web page display of the requirement listings of an employer.

FIG. 4 illustrates a sample web page for specifying the qualifications of a candidate.

FIG. 5 illustrates a sample web page listing requirements whose auctions are open.

FIG. 6 illustrates a sample web page that lists the details of a job requirement and that allows the submission of a bid.

FIG. 7 illustrates a sample web page that lists the bids of a provider.

FIG. 8 is a block diagram illustrating the components of a job placement system in one embodiment.

FIG. 9 is a flow diagram illustrating example processing for entry of a new job requirement.

FIG. 10 is a flow diagram illustrating example processing of the advance options web page.

FIG. 11 is a flow diagram illustrating example processing of adding a new candidate.

FIG. 12 is a flow diagram illustrating example processing of a bid.

FIG. 13 is a flow diagram illustrating example processing when an auction closes.

FIG. 14 is the flow diagram illustrating an example calculation of a match rating for a resource.

FIG. 15 is a flow diagram illustrating an example calculation of the fitness for the skills of a candidate.

FIG. 16 is a flow diagram illustrating an example calculation that determines the fitness of a required skill.

FIG. 17 is a flow diagram illustrating an example calculation to determine the fitness for availability.

FIG. 18 is a flow diagram illustrating an example calculation to determine the fitness for reservation.

FIG. 19 is a flow diagram illustrating an example calculation to determine fitness for rate.

### DETAILED DESCRIPTION

A method and system for selecting a resource is provided. In one embodiment, the resource system receives resource requirements that indicate target attributes of a target resource that is desired. The resource system receives offers to provide candidate resources to fill the resource requirements in an auction environment. Each candidate resource has candidate attributes that specify the characteristics of the candidate resource. The resource system generates a match rating for each candidate resource that indicates how closely the candidate attributes match the target attributes. The resource system then uses the match ratings to select a candidate resource whose candidate attributes best match the target attributes. In one embodiment, an employer advertises a job opening to be filled by a target resource, which is a person with certain skills who is available to work on the temporary basis. For example, the person may be a computer programmer with skills in certain programming languages. A target attribute of the resource requirements may be five years of experience in the C++ programming language. An employer may advertise that the job opening is to be filled with an employee on a full-time or temporary basis or with a contractor. The resource system allows the employer to advertise the desired skills of the job candidate along with other target attributes such as hourly rate and salary. The resource system allows offers (or bids) to be received for candidates to fill the job opening. Each candidate has their own set of skills. The resource system rates the candidates on their overall fitness to fill the position taking into consideration their skills, availability, and salary.

In one embodiment, the resource system uses a web-based employment auction system. The auction system provides various web pages for employers (or clients) to input their job requirements so that a reverse auction can be conducted to find a person who can best satisfy the requirements. The auction system provides various web pages for agencies (or members) to view the job requirements and offer (e.g., place a bid for) their candidates to fill the position. The agencies can view the details of other offers so that they can then offer a candidate who would be a better fit than any other currently offered candidate. The auction system uses a rating algorithm to identify how closely each candidate matches the job requirements. When the auction is closed, the auction system notifies the employer of those candidates with the highest ratings. The employer can then use a web-based interview system to arrange an interview with the candidates. The interviews may be conducted either in person, telephonically, or using an Internet-based meeting system. Once the interviews are complete, the employer notifies the resource system of the selected candidate. The resource system may also provide a web-based accounting system through which the agency of the selected candidate can submit bills to the employer.

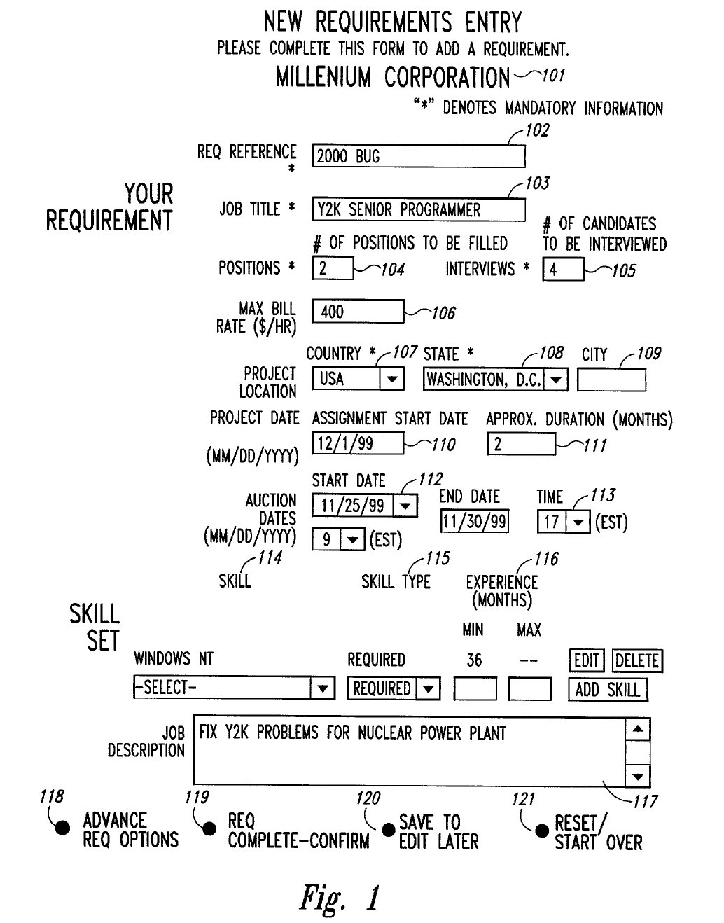

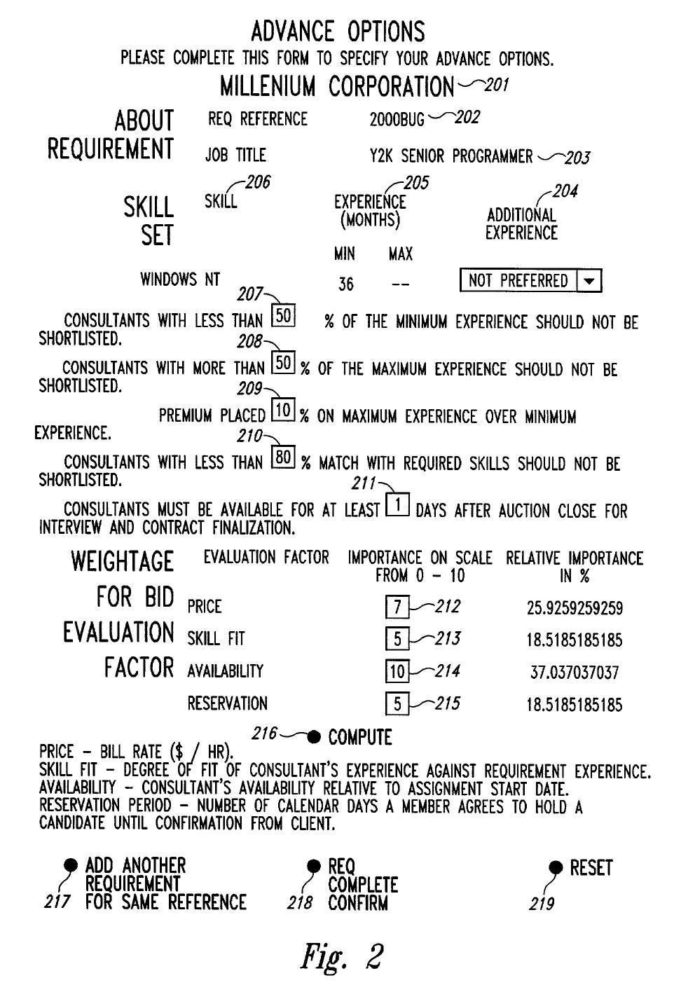

FIGS. 1 and 2 illustrate sample web pages for entry of job requirements. FIG. 1 illustrates a sample web page for entry of “standard” job requirements. Employer field 101 identifies the name of the employer, “Millennium Corp.”Reference field 102 contains a requirement reference, which is an identifier that allows the employer to group the various related jobs together. For example, an employer may want to track all jobs for fixing Y2K problems. Job field 103 indicates the job title associated with the requirement (e.g., “Y2K Senior Programmer”). Position field 104 indicates the number of positions with these requirements that the employer is looking to fill. Interview field 105 indicates the number of candidates that the employer is planning to interview. Maximum bill rate field 106 indicates the maximum rate that the employer is willing to pay. Project location fields 107, 108, and 109 indicate the country, state, and city in which the employee will work. Project data fields 110 and 111 indicate the start date of the project and the approximate duration of the project. Auction date fields 112 and 113 indicate the start and end date and time of the job auction. Skill set fields 114, 115, and 116 indicate the target skills, whether the skills are required or desired, and the minimum and maximum experience for each skill. For example, a skill may be experience in “Windows NT” programming. In this example, the employer selects a skill from a drop-down list of predefined skills and then selects the add skill button to add the skill requirement. Job description field 117 contains text describing the job. Buttons 118, 119, 120, and 121 allow the employer to specify advance requirement options, that the requirements are complete, that the requirements should be saved for later editing, or that the requirement should be reset.

FIG. 2 illustrates a sample web page for entry of advance options. These advance options allow the employer to specify how to rate certain conditions (e.g., experience in excess of maximum). Employer field 201 identifies the name of the employer, reference field 202 identifies the requirement reference, and job title field 203 identifies the job title. Skill set fields 204 and 205 identify the skill sets of the candidate that were entered as a standard requirement. Additional experience field 206 indicates how additional experience is to be treated (e.g., not preferred). The minimum experience for short list field 207 indicates the absolute minimum (i.e., floor) experience of candidates who will be considered. The absolute minimum experience is given as a percentage of the minimum experience. The short list is the list of candidates with the highest ratings who meet all the requirements and who would be interviewed if no more candidates were offered. The maximum experience for short list field 208 indicates the absolute maximum (e.g., ceiling) experience of candidates who will be considered. The premium on experience the field 209 indicates the premium placed on the amount of experience above the minimum experience but less than the maximum experience. The match percentage field 210 indicates the minimum rating of candidates who will be considered. The reservation field 211 indicates the number of days after the close of the auction that the candidate is required to stay available to allow the employer to make a decision. The factor weight fields 212, 213, 214, and 215 indicate the relative weight of the fitness factors used to calculate the rating. In this example, the fitness factors are price, skill, availability, and reservation. Once an employer enters the weights, the employer uses the compute button 216 to direct calculation of the relative importance. The relative importance of the factors is a percentage of the weight of a factor to the total weight of all the factors. Add another requirement button 217 allows an employer to enter another requirement for the same requirement reference. Requirement complete button 218 allows an employer to indicate that the entry of the requirements is complete. Reset button 219 allows an employer to reset the advance options to their default values.

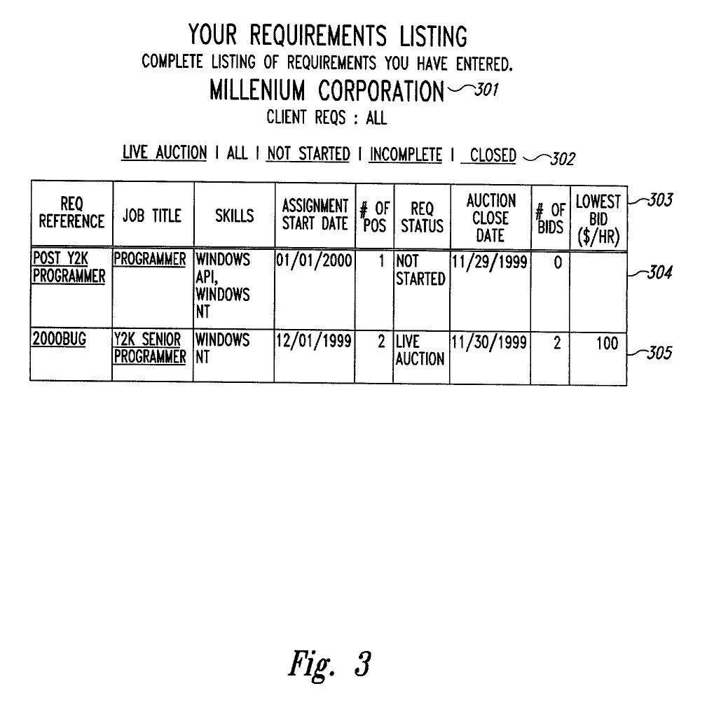

FIG. 3 illustrates a web page display of the requirement listings of an employer. The web page 300 includes an employer field 301, options fields 302, and requirement table 303. The options fields allow an employer to indicate the types of requirements to list. For example, the employer may want to list all requirements; only those requirements whose auction is open, closed, or not started; or requirements that are not yet fully specified. The requirement table contains columns indicating the requirement reference, job title, assignment start date, skill set, number of positions, requirement status, auction close date, number of bids, and the lowest bid. In this example, two job requirements are listed. The first requirement 304 is for the job title of “Programmer” whose auction has not yet started. The second requirement 305 is for the job title of “Y2K Senior Programmer” whose auction has already started. The auction for the second requirement has received two bids and the lowest bid is $100 per hour.

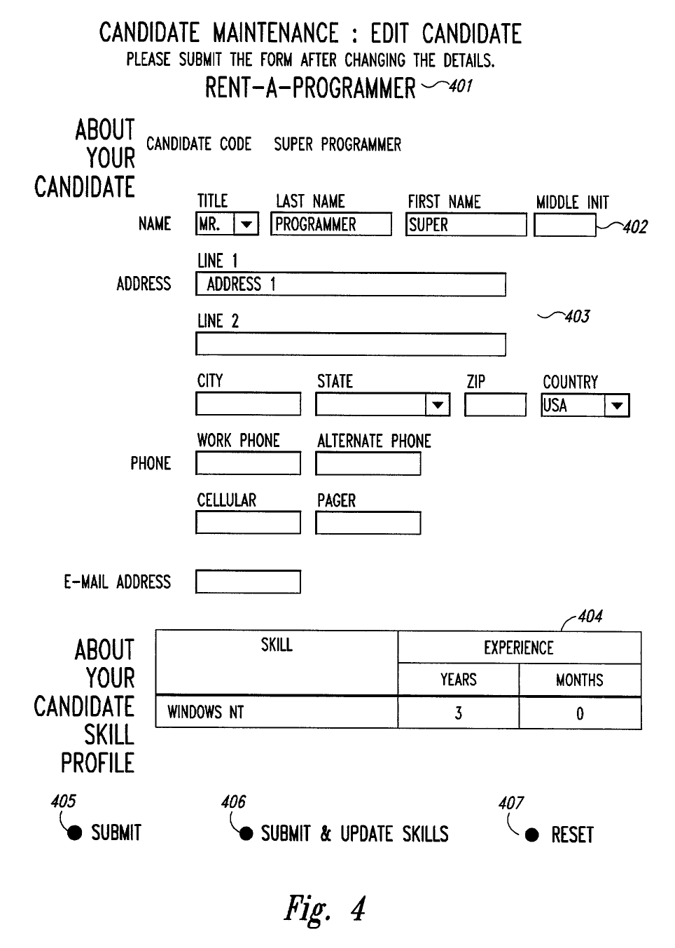

FIG. 4 illustrates a sample web page for specifying the qualifications of a candidate. Provider field 401 indicates the name of the provider (e.g., agency) of the candidate (e.g., “Rent-A-Programmer”).

The name fields 402 indicate the name of the candidate, and the additional information fields indicate the addresses and phone number of the candidate. The skill set field 403 indicates the skills of the candidate. The skills may be selected from a drop-down list of predefined skills. The submit button 405 allows the provider to submit a candidate, the submit and update skills button 406 allows the provider to submit and update skills of the candidate, and the reset button 407 allows the provider to reset the fields of the web page to a default value.

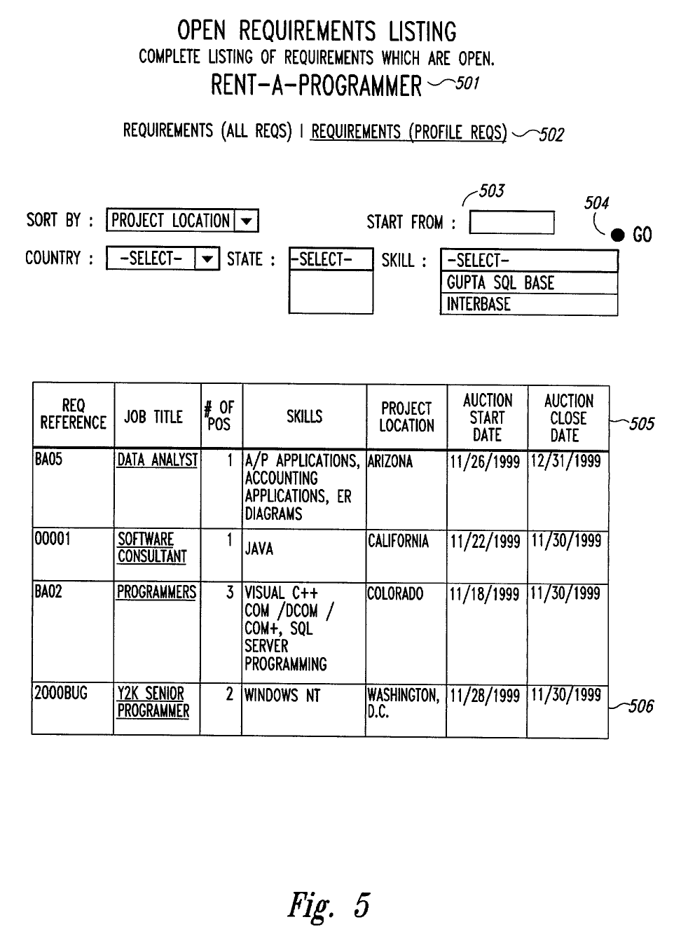

FIG. 5 illustrates a sample web page listing requirements lo whose auctions are open. Provider field 501 indicates the name of the provider of the candidate. The options fields 502 allow the provider to select whether to display all requirements or only those requirements that meet a predefined profile. The filter fields 503 allow the provider to indicate the order of the displayed listings and the criteria for selecting the listings to display. When a provider changes the filter, the provider selects the go button 504 to update the requirements listing. The requirement table 505 lists the job requirements that satisfy the filter.

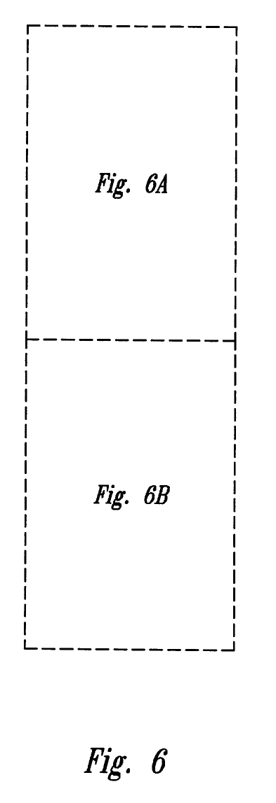

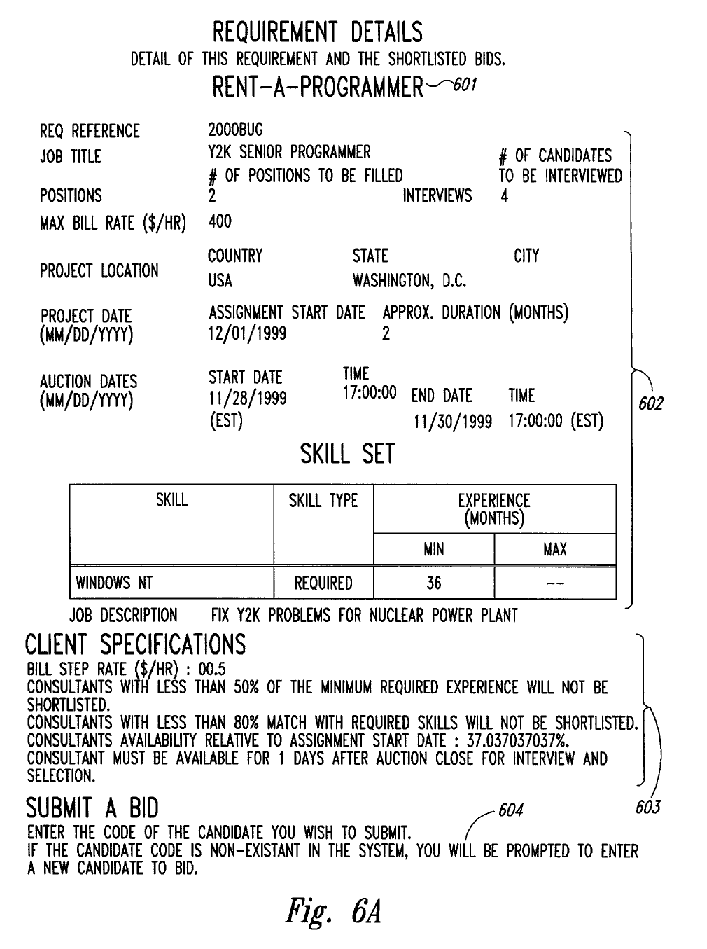

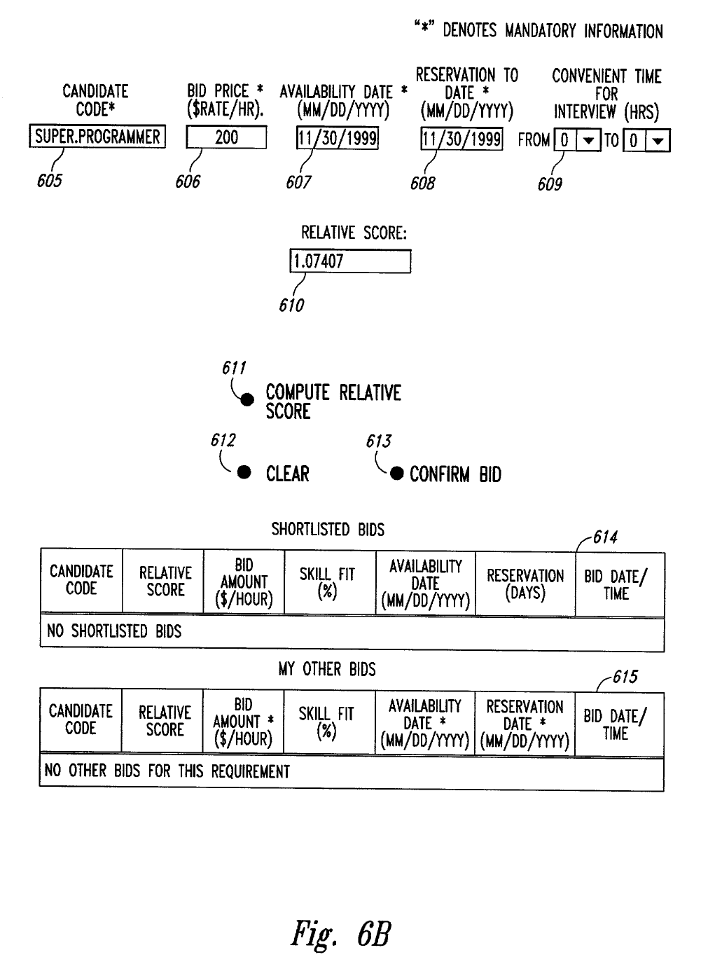

FIG. 6 illustrates a sample web page that lists the details of a job requirement and that allows the submission of a bid. Provider field 701 indicates the name of the provider. The requirement fields 702 indicate the various requirements of the job. The client specification fields 703 indicate various advance options relating to the job. The bid fields 704 allow a provider to submit a bid to provide a candidate for the job. The candidate code field 705 allows the provider to identify the candidate. The bid price field 706 allows the provider to enter the bid amount at a rate per hour. The availability date field 707 indicates the date at which the candidate is available to start the job. The reservation to date field 708 indicates the date until which the candidate is reserved. The interview time fields 709 indicate convenient times for an interview with the candidate. The relative score field 610 indicates the match rating for the candidate for this job. The compute relative score button 611 is used to recalculate to the match rating for the candidate. The clear button 612 is used to clear the bid fields, and the confirmed bid button 613 is used to submit the bid. The short list bid table 614 identifies those bids that are currently on the short list. The other bid table 615 identifies the other bids that are not on the short list.

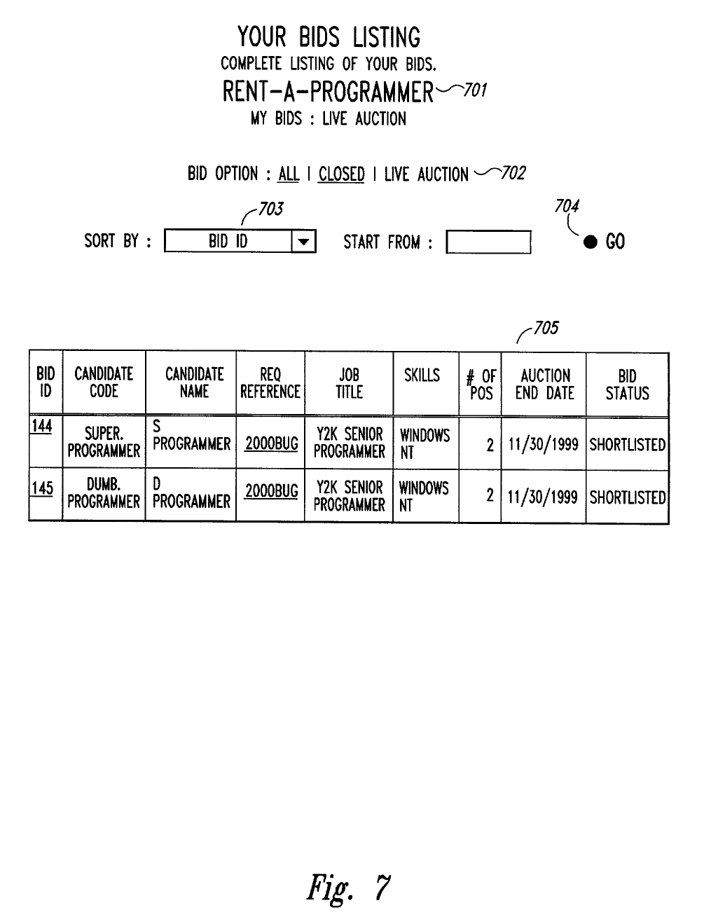

FIG. 7 illustrates a sample web page that lists the bids of a provider. Provider field 701 indicates the name of the provider. Options fields 702 allow the provider to select whether to display all the bids, or the bids for closed or open auctions. Filter fields 703 allow the user to specify how to order the bids and which bids to list. Go button 704 is used to regenerate the list after a filter fields have been changed. The bid table 705 contains in entry for each bid.

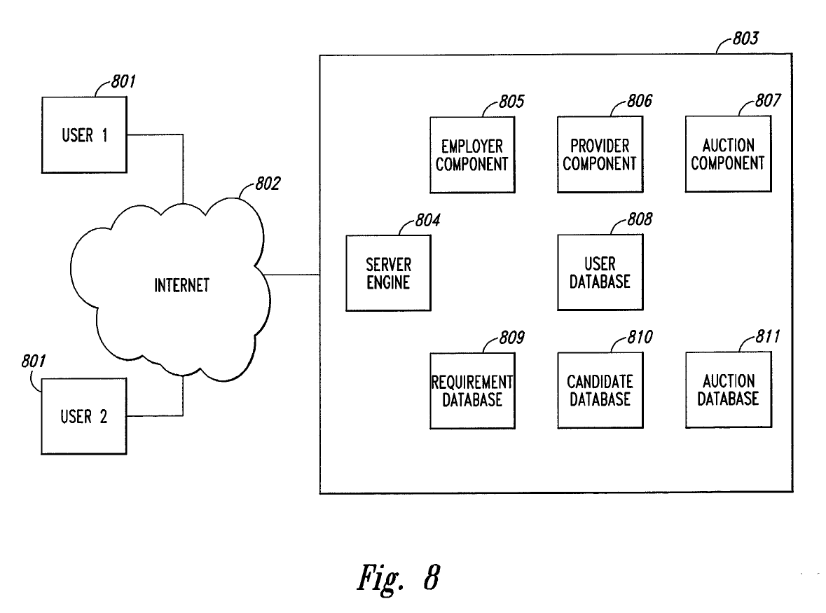

FIG. 8 is a block diagram illustrating the components of a job placement system in one embodiment. The user computers 801 and the server computer 803 are interconnected via the Internet 802. The computers may include a central processing unit, memory, input devices (e.g., keyboard and pointing device), output devices (e.g., display devices), and storage devices (e.g., disk drives). The memory and storage devices are computer-readable media that may contain computer instructions that implement the resource system. A computer-readable medium may also include a data transmission medium. The user computers may use a browser to access the web pages via the Internet. The server computer implements the job placement system. The job placement system includes a server engine 804, an employer component 805, a provider component 806, an auction component 807, a user database 808, a job requirements database 809, a candidate database 810, and an auction database 811. The server engine receives requests for web pages via the Internet and coordinates the generation and transmission of the web pages. The job placement system coordinates the defining of job requirements, registering of candidates, and conducting of the auctions for the jobs. The employer component coordinates the receiving of job requirements. The provider component coordinates the registering of candidates and the placing of bids on jobs whose auction is open. The auction component coordinates the closing of auctions and the notifying of the employer and providers of the results of the auction. The job placement system may also have an interview scheduling component to assist in the scheduling of the interviews between the employer and candidates with the highest rating. The job placement system may have an interview component to facilitate conducting an on-line interview. The job placement system may also have an accounting component for the submission of time sheets and subsequent payment. The user database contains an entry for each employer and provider that is registered to use the job placement system. The job requirement database contains information describing the requirements of each job that is defined. The candidate database contains an entry for each candidate that describes the candidate's qualifications. The auction database contains an entry for each job that indicates the bids that have been placed for that job.

One skilled in the art will appreciate that the concepts of the job placement system can be used in various environments other than the Internet. For example, the concepts can also be used in an electronic mail environment in which electronic mail messages may be used to provide information on jobs and to place bids. Also, various communication channels may be used such as a local area network, wide area network, or a point-to-point dial-up connection instead of the Internet. The server system may comprise any combination of hardware or software that can support these concepts. In particular, a web server may actually include multiple computers. A user system may comprise any combination of hardware software that interacts with the server system. Also, one skilled in the art will appreciate that the resource system can be used to auction many different types of resources. For example, the resource system can be used to auction many different types of resources.

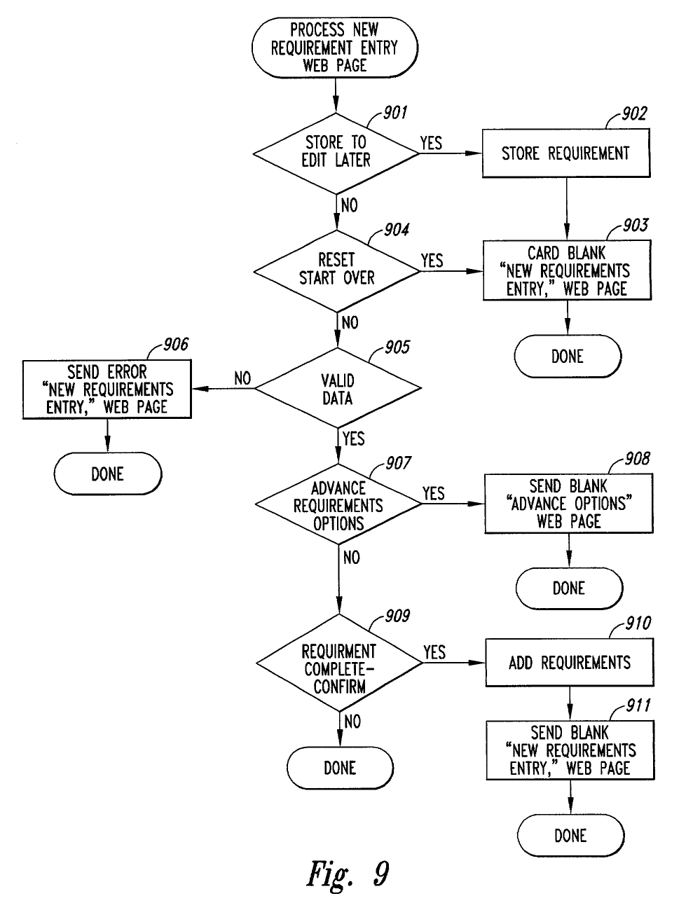

FIG. 9 is a flow diagram illustrating example processing for entry of a new job requirement. This routine is invoked after an employer has submitted a new requirement entry web page, such as the web page shown in FIG. 1. In decision block 901, if the user indicated to save the contents of the web page for later processing, then routine continues at block 902, else the routine continues at block 904. In block 902, the routine stores the requirements in the job requirement database with an indication that the requirements are not yet complete. In block 903, the routine sends a blank new requirements entry web page to the user computer and then completes. In decision block 904, if the user indicated to reset or start over, then the routine continues at block 903, else the routine continues at block 905. In decision block 905, if the data of the web page is valid, then the routine continues at block 907, else routine continues at block 906. The routine validates the values entered by the employer to ensure that they are consistent (e.g., ensuring that the end time of the auction is after the start time). In block 906, the routine sends a new requirements entry web page to the user that specifies which data is not valid and then completes. In decision block 907, if the user selected to enter advance requirements options, then the routine continues at block 908, else the routine continues at block 909. In block 908, the routine sends a blank advance options web page to the user and then completes. In decision block 909, if the user indicated that the requirements are complete, then the routine continues at block 910. In block 910, the routine adds the requirements to the job requirements database with an indication that the requirements are complete. In block 911, the routine sends a blank new requirements entry web page to the user and then completes.

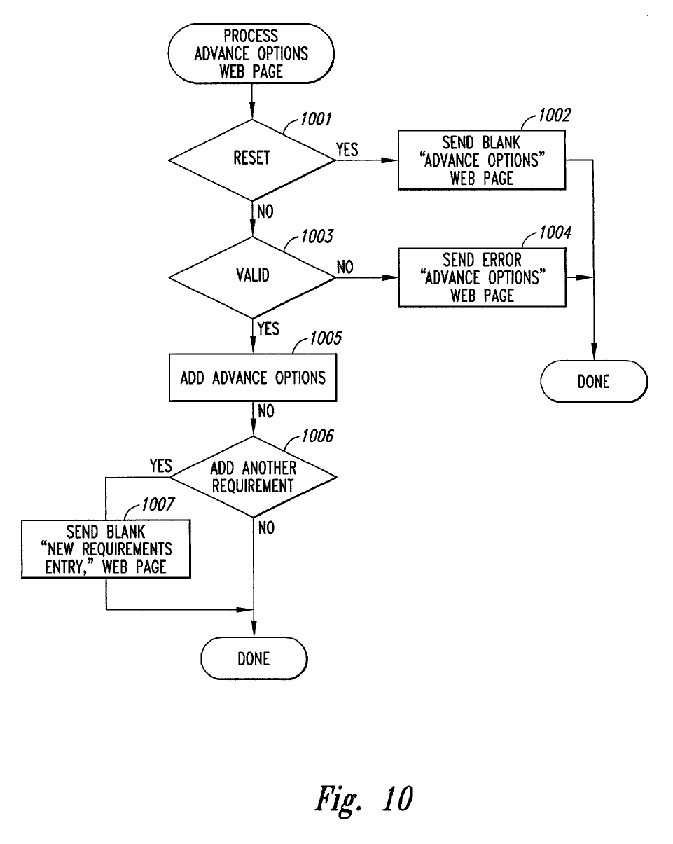

FIG. 10 is a flow diagram illustrating example processing of the advance options web page. This routine is invoked after an employer has submitted an advance option web page, such as the web page of FIG. 2. In decision block 1001, if the user indicated to reset the web page, then the routine continues at block 1002, else the routine continues at block 1003. In block 1002, the routine sends a blank advance options web page to the user and then completes. In decision block 1003, if the advance options are valid, then the routine continues at block 1005, else the routine continues at block 1004. In block 1004, the routine sends an advance options web page to the user indicating the invalid data and then completes. In block 1005, the routine adds the advance options to the job requirements database. In decision block 1006, if the user indicated to add another requirement to the job reference, then the routine continues at block 1007, else the routine completes. In block 1007, the routine sends a blank new requirement entry web page to the user and then completes

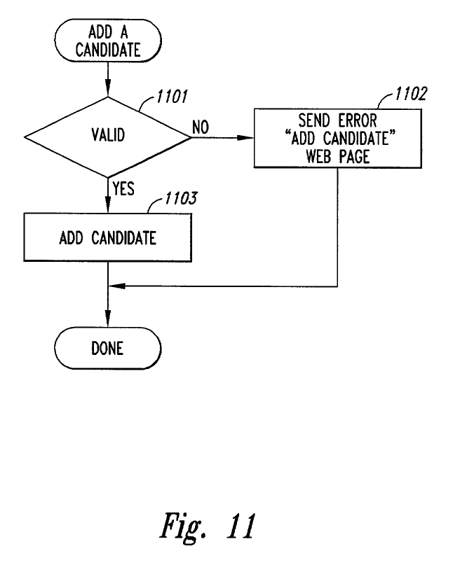

FIG. 11 is a flow diagram illustrating example processing of registering a new candidate. This routine is invoked when a user submits a candidate web page. In decision block 1101, if the data of the candidate web page is valid, then the routine continues at block 1103, else the routine continues at block 1102. In block 1102, the routine sends the add a candidate web page to the user indicating the invalid data and then completes. In block 1103, the routine adds the candidate information to the candidate database and completes.

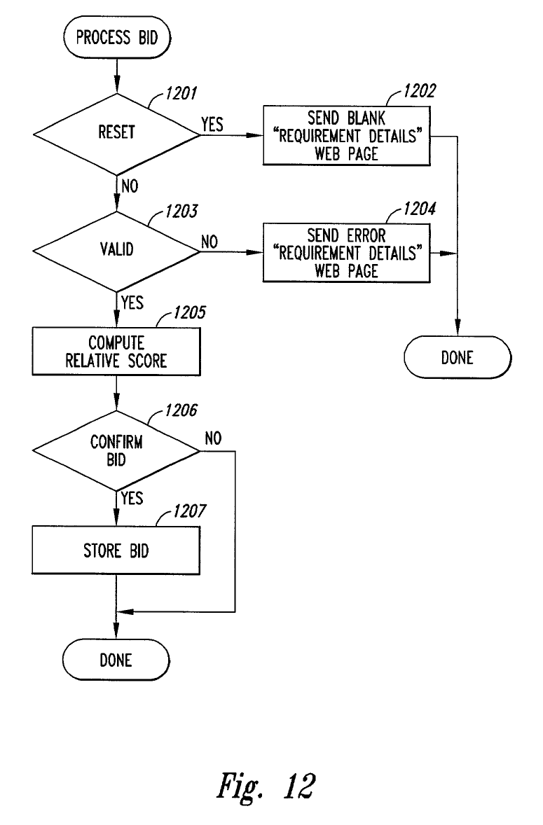

FIG. 12 is a flow diagram illustrating example processing of a bid. This routine is invoked when the user submits a bid on a job. In decision block 1201, if the user indicates to reset the web page, then the routine continues at block 1202, else the routine continues at block 1203. In block 1202, the routine sends a blank requirements detail web page to the user and then completes. In decision block 1203, if the bid data is valid, then the routine continues at block 1205, else the routine continues at block 1204. In block 1204, the routine a requirement details web page indicating the invalid data to the user and then completes. In block 1205, the routine calculates a relative score for the bid and sends a web page with relative score to the user. In decision block 1206, if the user indicates to confirm a bid, then the routine continues at step 1207, else the routine completes. In block 1207, the routine stores the bid in the bid database and then completes.

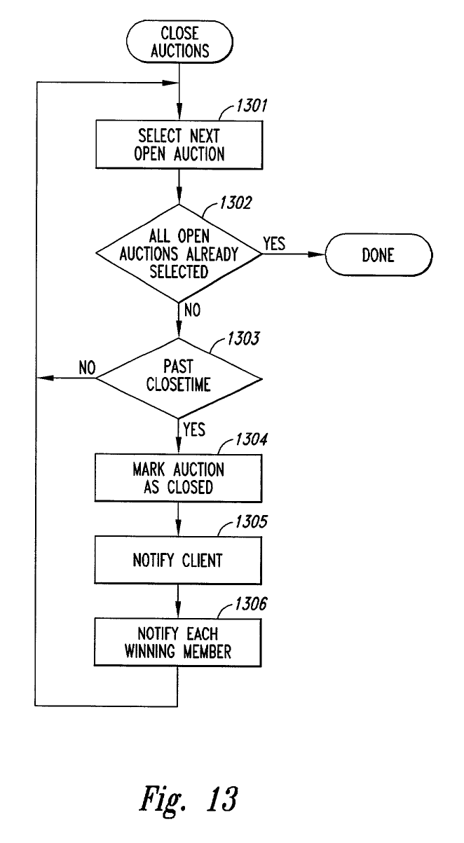

FIG. 13 is a flow diagram illustrating example processing when an auction closes. This routine may be invoked periodically to process the auctions that recently closed. In block 1301, the routine selects the next open auction from the auction database. In decision block 1302, if all the open auction have already been selected, then the routine completes, else the routine continues at block 1303. In decision block 1303, if the auction is past its close time, then the routine continues at block 1304, else the routine loops to block 1301 to select the next open auction. In block 1304, the routine marks the selected auction as closed. In block 1305, the routine notifies the employer of the results of the auction. In block 1306, the routine notifies each winning provider and then loops to block 1301 to select the next open auction.

### Match Rating

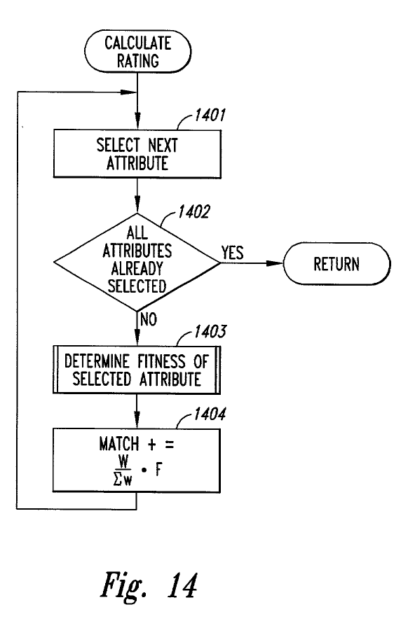

FIGS. 14-19 are flow diagrams illustrating the calculations of a match rating. In one embodiment, the resource system calculates a “fitness ratings” indicating how closely each resource attribute matches the target attribute. The resource system then combines the fitness ratings of the attributes using weighting factors to generate an overall match rating.

FIG. 14 is the flow diagram illustrating an example calculation of a match rating for a resource. This routine calculates a fitness of each attribute of the resource relative to the attributes of the target resource. In block 1401, the routine selects the next attribute starting with the first. In decision block 1402, if all the attributes have already been selected, then the routine completes, else the routine continues at block 1403. In block 1403, the routine invokes a determine fitness routine for the selected attribute. For example, when the resource is a person applying for job, then the attributes may be the skills, the availability, the reservation, and the hourly rate. In block 1404, the routine sums the weighted fitness of the selected attribute with the current match rating. The routine then loops to block 1401 to select the next attribute. When the routine completes, the variable match contains the match rating.

The following table defines the variables used in controlling the rating algorithm. These variables can be specified by the employer to indicate how to rate various attributes.

| Symbol | Meaning |
|---|---|
| A | Asymptote: value of skill fit that the calculated value approaches |
| | asymptotically as actual experiences increases |
| E_{cr} | Sum of candidate's experience in required skills |
| E_{cr i} | Candidate's experience in required skill ‘i’. |
| E_{cd} | Sum of candidate's experience in desired skills |
| E_{cd i} | Candidate's experience in desired skill ‘i’. |
| E_{r(min) i} | Minimum required experience in required skill ‘i’. |
| Er_{(max) i} | Maximum required experience in required skill ‘i’. |
| E_{d(min) i} | Minimum required experience in desired skill ‘i’. |
| E_{d(max) i} | Maximum required experience in desired skill ‘i’. |
| E_{Premium} | Premium placed on E_{cr(max)} over E_{cr(min)}. |
| P_{e floor} | Experience floor percentage. Experience less than |
| | P_{e floor} * E_{r(min) i} has no value for this requirement. |
| P_{e ceiling} | Experience ceiling percentage. Experience greater than |
| | P_{e ceiling} × E_{r(max) i} has no value for this requirement. |
| Fₐ | Fit of candidate's availability to the requirement |
| Fᵣₑₛ | Fit of candidate's reservation for the requirement |
| Fᵣ | Minimum degree of fit required |
| Fᵣₐₜₑ | Fit of rate |
| Nᵣ | Number of items in the required skills list |
| N_{d} | Number of items in the desired skills list |
| Dₚ | Date planned for assignment to start |
| Dₗ | Last allowed date for assignment to start |
| D_{c} | Date when consultant is available for assignment |
| Dₒ | Date (and time) when auction began |
| D_{b} | Date (and time) when bid was received |
| R | Reservation period - number of days after close of auction |
| R_{c} | Period during which provider agrees to reserve the candidate for |
| | this requirement |
| W_{f} | Raw weight for fit |
| Wₐ | Raw weight for availability |
| Wᵣ | Raw weight for reservation period |
| Wₚ | Raw weight for price |
| H_{c} | Consultant's hourly rate |
| H_{base} | Base rate per hour |

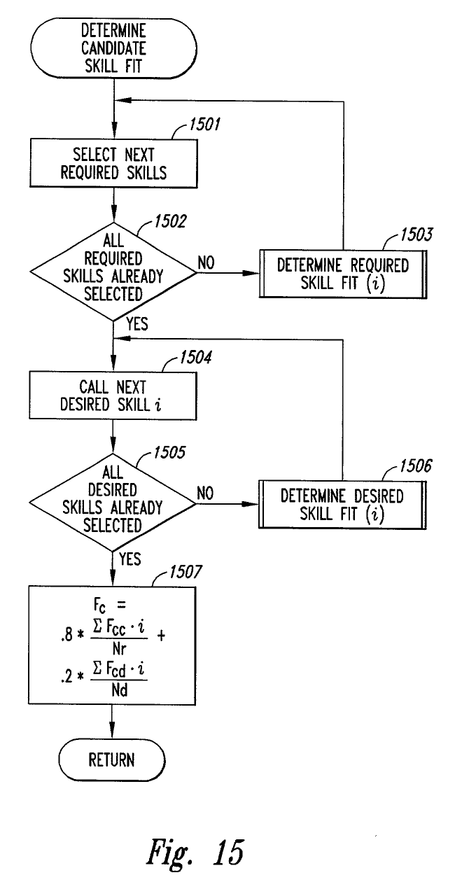

FIG. 15 is a flow diagram illustrating an example calculation of the fitness for the skills of a candidate. In this example, the skills include both required and desired skills. In blocks 1501-1503, the routine loops calculating a fitness value for each required skill. In block 1501, the routine selects the next required skill starting with the first. In decision block 1502, if all the required skills have already been selected, then the routine continues at block 1504, else the routine continues at block 1503. In block 1503, the routine invokes the routine to calculate the fitness for the selected required skill and then loops to block 1501 to select the next required skill. In blocks 1504-1506, the routine loops calculating a fitness value for each desired skill. In block 1504, the routine selects the next desired skill starting with the first. In decision block 1505, if all the desired skills have already been selected, then the routine continues at block 1507, else the routine continues at block 1506. In block 1506, the routine invokes a routine to calculate the fitness value for the selected desired skill and then loops to block 1504 to select the next desired skill. In block 1507, the routine combines the fitness values for the required skills and the fitness value for the desired is skills into an overall skill fitness for the candidate. In one embodiment, the routine uses the following equation to combine the fitness values of the required skill with the fitness of the desired skill.

$${F}_{c} = 0.8 \times \frac{{\sum }_{i = 1}^{i - {N}_{r}} {F}_{cr i}}{{N}_{r}} + 0.2 \times \frac{{\sum }_{j = 1}^{j = {N}_{d}} {F}_{cd j}}{{N}_{d}}$$

If there are no desired skills, then the weight factor for the required skills is 1.0, rather than 0.8. The routine returns.

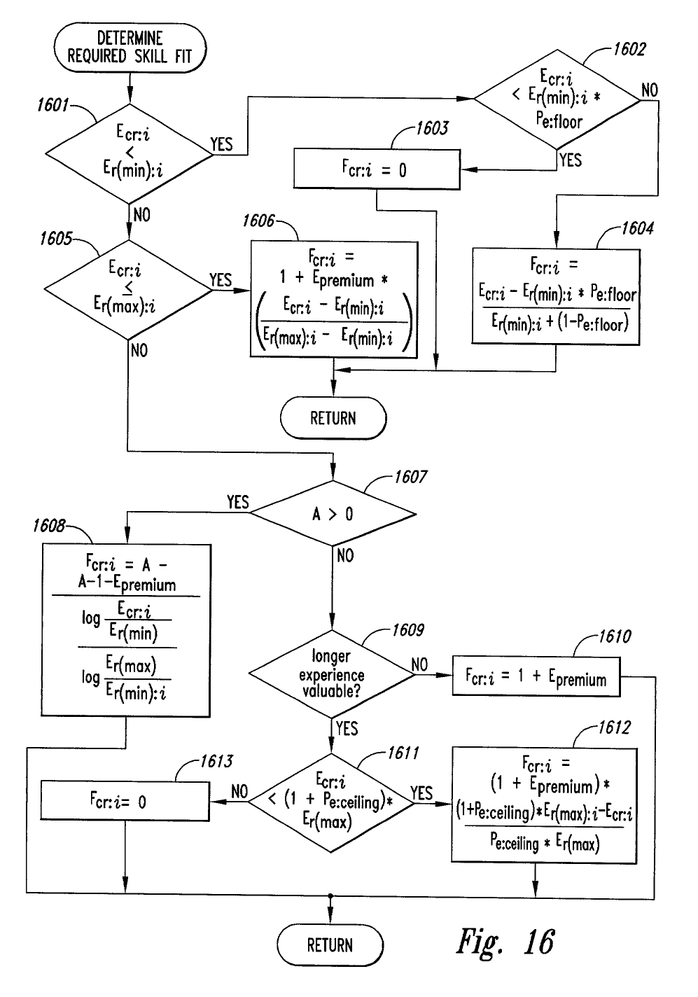

FIG. 16 is a flow diagram illustrating an example calculation that determines the fitness of a required skill. Although not shown, the fitness of desired skills is calculated in a similar manner. In decision block 1601, if the candidate's experience for the required skill (E_{cr:i}) is less than the minimum experience for the skill (E_{r(min):i}), then the routine continues at block 1602, else the routine continues at block 1605. In decision block 1602, if the candidate's experience for the skill (E_{cr:i}) is less than the floor experience (E_{r(min):i}*P_{e:floor}), then the routine continues at block 1603, else the routine continues at block 1604. In block 1603, the routine sets the fitness for the required skill (E_{cr.i}) to zero and then returns. In block 1604, the routine sets the fitness for the required skill (E_{cr:i}) to range linearly between the floor experience and the minimum experience according to the following equation:

$${F}_{cr i} = \frac{{E}_{cr i} - {E}_{r ( min ) i} \cdot {P}_{e floor}}{{E}_{r ( min ) i} \cdot ( 1 - {P}_{e floor} )}$$

The routine then returns. In decision block 1605, if the candidate's experience for the required skill (E_{r(max):i}) is less than or equal the maximum experience for the skill (E_{cr:i}), then the routine continues at block 1606, else the routine continues at block 1607. In block 1606, the routine sets the candidate's fitness to one plus a fraction of the experience premium based on the ratio of the candidate's experience (F_{cr:i}) to the difference between the maximum experience and minimum experience as indicated by the following equation:

$${F}_{cr i} = 1 + {E}_{Pr emium} \cdot \frac{{E}_{cr i} - {E}_{r ( min )}}{{E}_{r ( max ) i} - {E}_{r ( min ) i}}$$

The routine then returns. In block 1607, if the asymptote is greater than zero, then the routine continues at block 1608, else the routine continues at block 1609. In a block 1608, the routine sets the candidate's fitness as indicated by the following equation:

$${F}_{cr i} = A - \frac{A - 1 - {E}_{Pr emium}}{[ \frac{Log \frac{{E}_{cr i}}{{E}_{r ( min )}}}{Log \frac{{E}_{r ( min )}}{{E}_{r ( min ) i}}} ]}$$

The routine then returns. In block 1609, if longer experience is valued, then the routine continues at block 1611, else the routine continues at block 1610. In block 1610, the routine sets the candidate's fitness to one plus the experience premium and then returns. In decision block 1611, if the candidate's experience is less than the ceiling experience, then the routine continues at block 1612, else the routine continues at block 1613. In block 1612, the routine sets the candidate's fitness to one plus the experience premium times a ratio of the candidate's experience to the difference between the ceiling experience and the maximum experience as indicated by the following equation:

$${F}_{cr i} = ( 1 + {E}_{Pr emium} ) \cdot \frac{( 1 + {P}_{e ceiling} ) \cdot {E}_{r ( max )} - {E}_{cr i}}{{P}_{e Ceiling} \cdot {E}_{r max}}$$

In block 1613, the routine sets the candidate's fitness to zero and then returns.

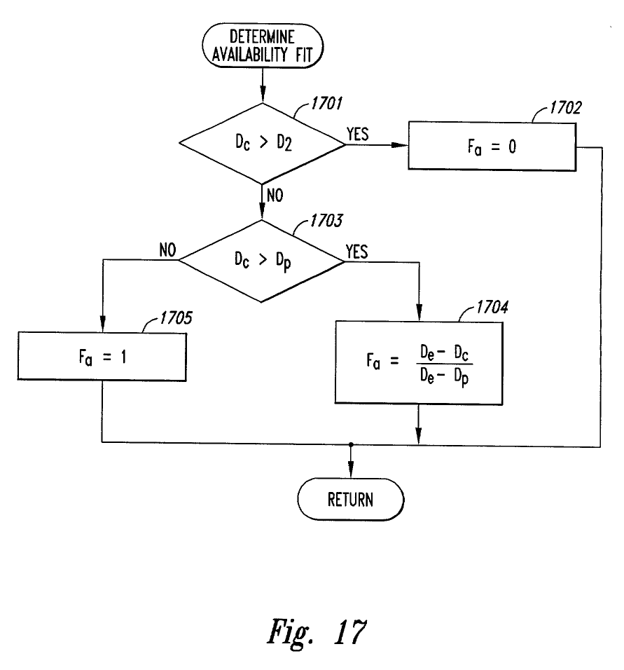

FIG. 17 is a flow diagram illustrating an example calculation to determine the fitness for availability (D_{c}). In decision block 1701, if the candidate's availability (D_{c}) is greater than the latest availability date (Dₗ), then the routine continues at block 1702, else the routine continues at block 1703. In block 1702, the routine sets the candidate's fitness (Fₐ) to zero and then returns. In decision block 1703, if the candidate's availability (D_{c}) is later than the planned availability (Dₚ), then the routine continues at block 1704, else the routine continues at block 1705. In block 1704, the routine sets the candidate's fitness to the ratio of the difference between the latest availability (Dₗ) and the candidate's availability (D_{c}) to the difference between the latest availability (Dₗ) and the desired availability (Dₚ). The routine then returns. In block 1705, the routine sets the candidate's fitness to 1 and then returns.

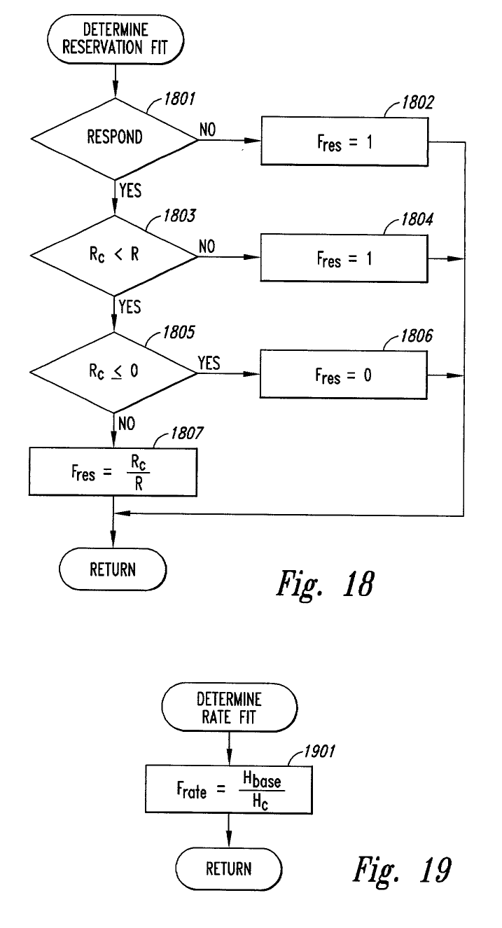

FIG. 18 is a flow diagram illustrating an example calculation to determine the fitness for reservation. In decision block 1801, if a reservation is specified, then the routine continues at block 1803, else the routine continues at block 1802. In block 1802, the routine sets the candidate's fitness (Fᵣₑₛ) to one and then returns. In decision block 1803, if the candidate's reservation (R_{c}) is less than the target reservation (R), then the routine continues at block 1805, else the routine continues at block 1804. In block 1804, the routine sets the candidate's fitness to one and then returns. In decision block 1805, if the candidate's reservation is less than or equal to zero, then routine continues at block 1806, else the routine continues at block 1807. In block 1806, the routine sets the candidate's fitness to zero and then returns. In block 1807, the routine sets the candidate's fitness to the ratio of the candidate's reservation to the target reservation and then returns.

FIG. 19 is a flow diagram illustrating an example calculation to determine fitness for rate. In block 1901, the routine sets the candidate's fitness (Fᵣₐₜₑ) to the base rate (H_{base}) divided by the candidate's rate (H_{c}) and then returns.

From the foregoing, it will be appreciated that although specific embodiments of the job placement system have been described for purposes of illustration, various modifications may be made without deviating from the spirit in the scope of the invention. Accordingly the invention is not limited except by the following claims.

1. A method in a computer system for selection of a resource, the method comprising:
providing a resource requirement indicating target attributes of a target resource;
receiving a plurality of offers to provide a candidate resource, each candidate resource having candidate attributes;
for each offered candidate resource, generating a match rating between the candidate attributes of the candidate resource and the target attributes of the target resource; and
selecting a candidate resource based on the generated match ratings.

2. The method of claim 1 including receiving the resource requirement from a consumer of the resource.

3. The method of claim 1 wherein the offers are received from a suppliers of candidate resources.

4. The method of claim 1 wherein the resources are people and the attributes include skills of the person and hourly rate.

5. The method of claim 1 wherein the computer system is a server connected to the Internet.

6. A method in a computer system for conducting a reverse auction for services of people, the method comprising:
receiving an indication of requirements of a person from a consumer of services;
advertising the indicated requirements;
receiving a plurality of offers to provide a person;
generating a match rating for each offered person indication how well that person meets the requirements; and
selecting an offered person based on the match ratings.

7. The method of claim 6 including selecting multiple offered persons based on the match ratings.

8. The method of claim 6 wherein the requirements includes skills.

9. The method of claim 6 wherein the requirements include start date.

10. The method of claim 6 wherein the requirements includes reservation date.

11. The method of claim 6 wherein the requirement includes pricing information.

12. The method of claim 6 wherein the generating of the match rating includes identifying how closely a person matches each requirement.

13. A method in a computer system for evaluating an offered resource, the resource having attributes, each attribute having a resource value, the method comprising:
identifying target values for each attribute;
for each attribute, generating an attribute match rating indicating how well the corresponding resource value matches the corresponding target value; and
combining the generated attribute match ratings to generate an overall match rating for the offered resource.

14. The method of claim 13 wherein the combining of the generated attribute match ratings includes applying a weight factor to each attribute match rating.

15. The method of claim 13 wherein the resource is offered at a reverse auction.

16. The method of claim 13 wherein the attributes include skills of a person.

17. The method of claim 13 wherein the attributes include rate of a person.

18. The method of claim 13 wherein the attributes include availability of a person.

19. The method of claim 13 wherein the attributes include reservation of a person.

20. A computer system for coordinating the providing of resources, comprising:
an auction component that receives resource requirements, that advertises the received resource requirements, that receives a description of a resource, that places a bid to provide the resource, and that selects those resources that most closely match the received resource requirements;
an interview component that coordinates the interviewing of the selected resource by the provider of the resource requirements;
a selection component that coordinates the selection of an interviewed resource; and
an accounting component that coordinates the submitting of bills provided by the selected resource.

21. The computer system of claim 20 wherein the computer system is a web server.

22. The computer system of claim 20 wherein the resources are people.

23. The computer system of claim 20 wherein the auction component rates how closely a resource matches the resource requirements.
